(19) United States
(12) Patent Application Publication
(10) Pub. No.: US 2024/0426332 A1
(43) Pub. Date: Dec. 26, 2024

(54) Connector Component and Connector

(71) Applicants: Tyco Electronics (Suzhou) Ltd., Suzhou City (CN); Tyco Electronics (Shanghai) Co., Ltd., Shanghai (CN)

(72) Inventors: Shuanglin (Seven) Yuan, Suzhou (CN); Feng (Charles) Wan, Shanghai (CN); Zhaowen Zhou, Shanghai (CN)

(73) Assignees: Tyco Electronics (Suzhou) Ltd., Suzhou City (CN); Tyco Electronics (Shanghai) Co., Ltd., Shanghai (CN)

(21) Appl. No.: 18/753,637

(22) Filed: Jun. 25, 2024

(30) Foreign Application Priority Data
Jun. 25, 2023 (CN) 202321610508.4

(51) Int. Cl. F16B 21/08

(52) U.S. Cl. CPC F16B 21/088; F16B 2200/20

(57) ABSTRACT

A connector component incudes an engagement hole adapted to engage with an elastic buckle of another connector component, and a pair of radial protrusions formed on an inner surface of the engagement hole. The connector component is rotatable around the elastic buckle inserted into the engagement hole between an assembly position and a disassembly position. The connector component is adapted such that, with the connector component is in the assembly position, the elastic buckle is not radially pressed by the radial protrusion and a radial interference amount between the elastic buckle and the engagement hole is equal to a predetermined interference amount. With the connector component in the disassembly position, the elastic buckle is radially pressed by the radial protrusion, and the radial interference amount between the elastic buckle and the engagement hole is less than the predetermined interference amount reducing an unlocking force required to unlock the elastic buckle.

### CROSS-REFERENCE TO RELATED APPLICATION

This application claims the benefit of Chinese Patent Application No. CN202321610508.4 filed on Jun. 25, 2023 in the State Intellectual Property Office of China, the whole disclosure of which is incorporated herein by reference.

### FIELD OF THE INVENTION

Embodiments of the present disclosure relate to a connector component and a connector comprising the connector component.

### BACKGROUND

In the prior art, it is sometimes necessary to use a harpoon type elastic buckle structure to lock two connector components together. The harpoon style elastic buckle structure usually includes a pair of elastic buckle halves, which are facing and separated from each other, like a harpoon. Typically, the elastic buckle half includes an elastic arm portion and a locking protrusion formed at the end of the elastic arm portion. The locking protrusion is used to rest against the annular step inside the engagement hole to keep the elastic buckle in the engagement hole. The harpoon style elastic buckle structure can provide great retention force, ensuring that the two connector components are reliably locked together without detachment. However, this will make it difficult to disassemble the two connector components because the unlocking force required to unlock the harpoon type elastic buckle structure is very high.

### SUMMARY

According to an embodiment of the present disclosure, a connector component incudes an engagement hole adapted to engage with an elastic buckle of another connector component, and a pair of radial protrusions formed on an inner surface of the engagement hole. The connector component is rotatable around the elastic buckle inserted into the engagement hole between an assembly position and a disassembly position. The connector component is adapted such that, with the connector component is in the assembly position, the elastic buckle is not radially pressed by the radial protrusion and a radial interference amount between the elastic buckle and the engagement hole is equal to a predetermined interference amount. With the connector component in the disassembly position, the elastic buckle is radially pressed by the radial protrusion, and the radial interference amount between the elastic buckle and the engagement hole is less than the predetermined interference amount reducing an unlocking force required to unlock the elastic buckle.

### BRIEF DESCRIPTION OF THE DRAWINGS

The invention will now be described by way of example with reference to the accompanying Figures, of which:

FIG. 1 shows an illustrative assembly view of two connector components according to an exemplary embodiment of the present invention;

FIG. 2 shows an illustrative disassembly view of two connector components according to an exemplary embodiment of the present invention;

FIG. 3 shows an illustrative perspective view of a connector component according to an exemplary embodiment of the present invention;

FIG. 4 shows an illustrative perspective view of another connector component according to an exemplary embodiment of the present invention;

FIG. 5 shows a plan view of two connector components according to an exemplary embodiment of the present invention, wherein the two connectors are in the assembly position; and

FIG. 6 shows a plan view of two connector components according to an exemplary embodiment of the present invention, with the two connectors in the disassembly position.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to a an embodiment of the present disclosure, a connector component includes engagement hole formed therein for engaging with an elastic buckle on another connector component, and a pair of radial protrusions are formed on the inner surface of the engagement hole. The connector component can be rotated around the elastic buckle inserted into the engagement hole between an assembly position and a disassembly position. When the connector component is in the assembly position, the elastic buckle is not radially pressed by the radial protrusion, so that a radial interference amount between the elastic buckle and the engagement hole is equal to a predetermined interference amount. When the connector component is in the disassembly position, the elastic buckle is radially pressed by the radial protrusion, so that the radial interference amount between the elastic buckle and the engagement hole is less than the predetermined interference amount, in order to reduce an unlocking force required to unlock the elastic buckle.

According to another embodiment, a connector includes the above connector component, and another connector component which is formed with an elastic buckle suitable for engagement with the engagement hole of the connector component.

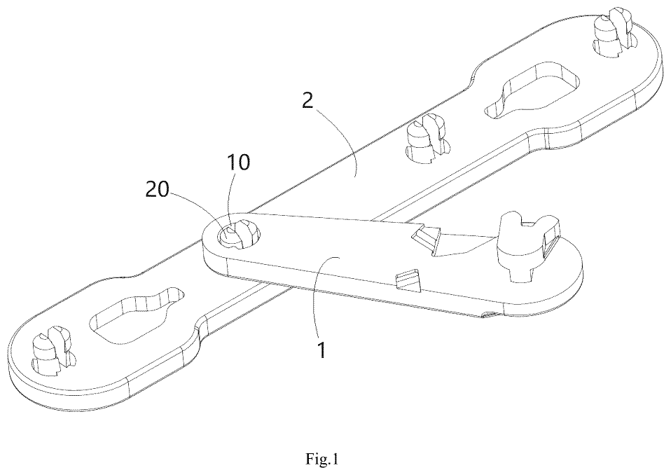

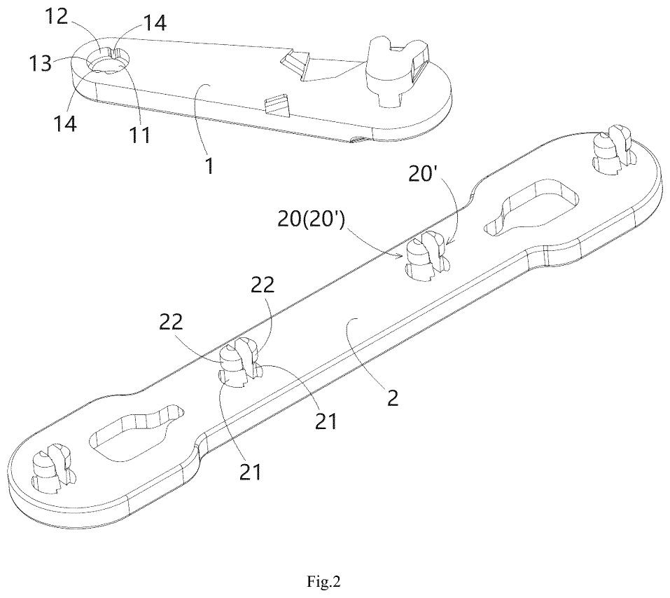

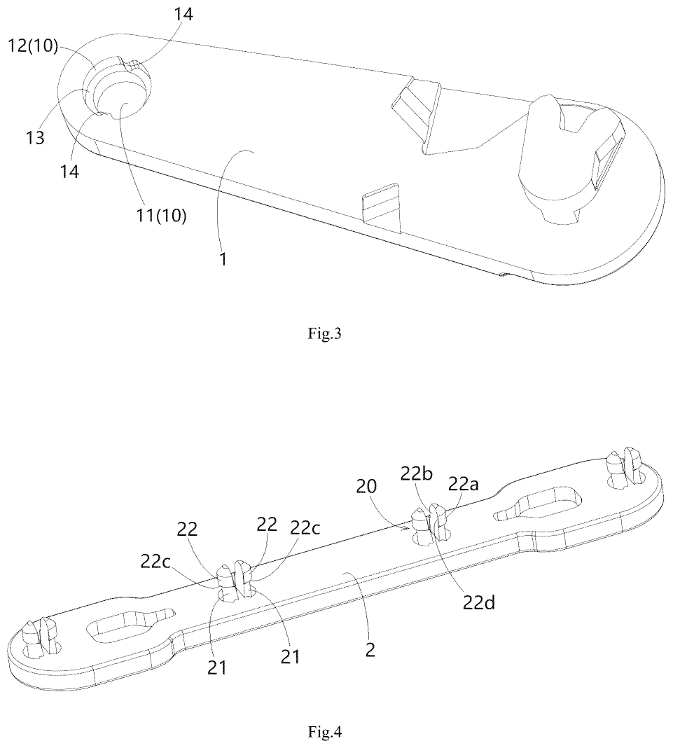

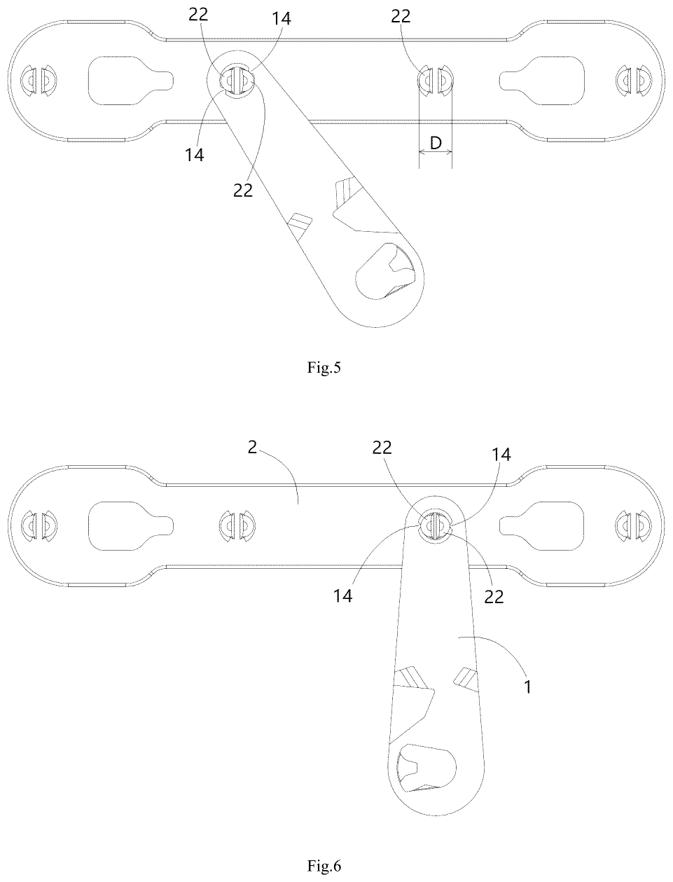

FIG. 1 shows an illustrative assembly view of two connector components 1 and 2 according to an exemplary embodiment of the present invention. FIG. 2 shows an illustrative disassembly view of two connector components 1 and 2 according to an exemplary embodiment of the present invention. FIG. 3 shows an illustrative perspective view of a connector component 1 according to an exemplary embodiment of the present invention. FIG. 4 shows an illustrative perspective view of the another connector component 2 according to an exemplary embodiment of the present invention. FIG. 5 shows a plan view of two connector components 1 and 2 according to an exemplary embodiment of the present invention, wherein the two connectors 1 and 2 are in the assembly position. FIG. 6 shows a plan view of two connector components 1 and 2 according to an exemplary embodiment of the present invention, wherein the two connectors 1 and 2 are in the disassembly position.

As shown in FIGS. 1-6, in an exemplary embodiment of the present invention, a connector component 1 is disclosed. An engagement hole 10 is formed in the connector component 1 for engaging with an elastic buckle 20 on another connector component 2. A pair of radial protrusions 14 are formed on the inner surface of the engagement hole 10, and the connector component 1 can be rotated around the elastic buckle 20 inserted into the engagement hole 10 between an assembly position (as shown in FIG. 5) and a disassembly position (as shown in FIG. 6).

When the connector component 1 and the another connector component 2 are in the assembly position, the elastic buckle 20 is not pressed by the radial protrusions 14. In this position, the radial interference amount between the elastic buckle 20 and the engagement hole 10 is equal to the predetermined interference amount. When the connector component 1 and the another connector component 2 are in the disassembly position, the elastic buckle 20 is pressed by the radial protrusions 14. This causes the radial interference amount between the elastic buckle 20 and the engagement hole 10 to be less than the predetermined interference amount, in order to reduce the unlocking force required to unlock the elastic buckle 20.

In the illustrated embodiments, an annular step 13 is formed on the inner peripheral surface of the engagement hole 10. The step surface of the annular step 13 is perpendicular to the axis of the engagement hole 10. The step surface of the annular step 13 is used to interfere with the locking protrusion 22 on the elastic buckle 20, in order to keep the elastic buckle 20 in the engagement hole 10.

When the connector component 1 and the another connector component 2 are in the assembly position, the radial interference amount between the step surface of the annular step 13 and the locking protrusion 22 of the elastic buckle 20 is equal to the predetermined interference amount. When the connector component 1 and the another connector component 2 are in the disassembly position, the radial interference amount between the step surface of the annular step 13 and the locking protrusion 22 of the elastic buckle 20 is less than the predetermined interference amount.

In the illustrated embodiments, the connector component 1 has a first side and a second side opposite to each other in the axial direction of the engagement hole 10. The engagement hole 10 comprises a first aperture portion 11 and a second aperture portion 12 formed in the first and second sides of the connector component 1, respectively. The first aperture portion 11 is coaxial with the second aperture portion 12, and the inner diameter of the first aperture portion 11 is smaller than that of the second aperture portion 12, in order to form the aforementioned annular step 13 within the engagement hole 10. The pair of radial protrusions 14 are formed on the inner peripheral surface of the second aperture portion 12 and are opposite to each other in a radial direction of the second aperture portion 12.

The radial protrusion 14 extends along the axial direction of the engagement hole 10 from the second side of the connector component 1 to the step surface of the annular step 13. The radial protrusion 14 protrudes along the radial direction of the engagement hole 10 from the inner peripheral surface of the second aperture portion 12 to the position near the inner peripheral surface of the first aperture portion 11.

In another exemplary embodiment of the present invention, a connector is also disclosed. This connector includes the aforementioned connector component 1 and the another connector component 2. An elastic buckle 20 is formed on the another connector component 2. The elastic buckle 20 is suitable for engagement with the engagement hole 10 in the aforementioned connector component 1.

The elastic buckle 20 comprises a pair of elastic buckle halves 20′, which face to each other and are separated from each other. The elastic buckle half 20′ includes an elastic arm portion 21 and a locking protrusion 22 formed at the end of the elastic arm portion 21. The locking protrusion 22 is used to interfere with the annular step 13 inside the engagement hole 10, in order to keep the elastic buckle 20 in the engagement hole 10.

The locking protrusion 22 is semi-cylindrical, with an arc-shaped peripheral surface 22a and a semi-annular bottom surface 22c perpendicular to the arc-shaped peripheral surface 22a. The semi-annular bottom surface 22c is used to interfere with the step surface of the annular step 13. When the connector component 1 is rotated around the elastic buckle 20 between the assembly position and the disassembly position, the radial protrusion 14 slides along the arc-shaped outer peripheral surface 22a of the locking protrusion 22.

The locking protrusion 22 also has a flat inner side surface 22b, and the flat inner side surfaces 22b of the pair of locking protrusions 22 face each other. When the connector component 1 and the another connector component 2 are in the assembly position, the radial protrusion 14 is close to a side edge 22d where the arc-shaped outer peripheral surface 22a intersects with the flat inner side surface 22b. When the connector component 1 and the another connector component 2 are in the disassembly position, the radial protrusion 14 is located in a circumferential middle location of the arc-shaped outer peripheral surface 22a.

When the connector component 1 and the another connector component 2 are in the assembly position, the pair of elastic buckle halves 20′ of the elastic buckle 20 are not pressed by the radial protrusions 14, causing the pair of elastic buckle halves 20′ of the elastic buckle 20 to be in a natural state. At this point, the radial interference amount between the elastic buckle 20 and the engagement hole 10 is roughly equal to the difference between the maximum radial dimension D of the locking protrusion 22 on the elastic buckle 20 and the inner diameter of the first aperture portion 11 of the engagement hole 10 (this difference is the predetermined interference amount mentioned above).

In the illustrated embodiments, when the connector component 1 and the another connector component 2 are in the disassembly position, the elastic buckle 20 is pressed by the radial protrusions 14, causing the pair of elastic buckle halves 20′ of the elastic buckle 20 to move radially towards each other. This reduces the maximum radial size of the locking protrusion 22 on the elastic buckle 20, resulting in a radial interference amount between the elastic buckle 20 and the engagement hole 10 less than the predetermined interference amount mentioned above, in order to reduce the radial unlocking force required to unlock the elastic buckle 20.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector component, comprising:
an engagement hole formed therein and adapted to engage with an elastic buckle of another connector component;
a pair of radial protrusions are formed on an inner surface of the engagement hole, the connector component rotatable around the elastic buckle inserted into the engagement hole between an assembly position and a disassembly position, wherein the connector component is adapted such that:
with the connector component is in the assembly position, the elastic buckle is not radially pressed by the radial protrusion and a radial interference amount between the elastic buckle and the engagement hole is equal to a predetermined interference amount; and
with the connector component is in the disassembly position, the elastic buckle is radially pressed by the radial protrusion, and the radial interference amount between the elastic buckle and the engagement hole is less than the predetermined interference amount reducing an unlocking force required to unlock the elastic buckle.

2. The connector component according to claim 1, wherein an annular step is formed on the inner surface of the engagement hole.

3. The connector component according to claim 2, wherein the step surface of the annular step is perpendicular to the axis of the engagement hole.

4. The connector component according to claim 3, wherein the step surface of the annular step is adapted to interfere with a locking protrusion on the elastic buckle to maintain the elastic buckle in the engagement hole.

5. The connector component according to claim 4, wherein when the connector component is in the assembly position, the radial interference amount between the step surface of the annular step and the locking protrusion of the elastic buckle is equal to the predetermined interference amount.

6. The connector component according to claim 5, wherein when the connector component is in the disassembly position, the radial interference amount between the step surface of the annular step and the locking protrusion of the elastic buckle is less than the predetermined interference amount.

7. The connector component according to claim 6, wherein the connector component has a first side and a second side opposite to each other in an axial direction of the engagement hole, the engagement hole comprises a first aperture portion and a second aperture portion formed in the first and second sides of the connector component, respectively.

8. The connector component according to claim 7, wherein the first aperture portion is coaxial with the second aperture portion and an inner diameter of the first aperture portion is smaller than that of the second aperture portion to form the annular step within the engagement hole.

9. The connector component according to claim 8, wherein the pair of radial protrusions are formed on the inner peripheral surface of the second aperture portion and are opposite to each other in a radial direction of the second aperture portion.

10. The connector component according to claim 9, wherein the radial protrusion extends along the axial direction of the engagement hole from the second side of the connector component to the step surface of the annular step.

11. The connector component according to claim 10, wherein the radial protrusion protrudes along a radial direction of the engagement hole from the inner peripheral surface of the second aperture portion to a position close to the inner peripheral surface of the first aperture portion.

12. A connector, comprising:
a first connector component and a second connector component, the first connector component including:
an engagement hole formed therein and adapted to engage with an elastic buckle of the second connector component;
a pair of radial protrusions are formed on an inner surface of the engagement hole, the first connector component rotatable around the elastic buckle inserted into the engagement hole between an assembly position and a disassembly position, wherein the first connector component is adapted such that:
with the first connector component is in the assembly position, the elastic buckle is not radially pressed by the radial protrusion and a radial interference amount between the elastic buckle and the engagement hole is equal to a predetermined interference amount; and
with the first connector component is in the disassembly position, the elastic buckle is radially pressed by the radial protrusion, and the radial interference amount between the elastic buckle and the engagement hole is less than the predetermined interference amount reducing an unlocking force required to unlock the elastic buckle.

13. The connector according to claim 12, wherein the elastic buckle comprises a pair of elastic buckle halves, which face each other and are separated from each other.

14. The connector according to claim 13, wherein the elastic buckle half comprises an elastic arm portion and a locking protrusion formed at the end of the elastic arm portion.

15. The connector according to claim 14, wherein the locking protrusion is used to interfere with the annular step inside the engagement hole to keep the elastic buckle in the engagement hole.

16. The connector according to claim 12, wherein the locking protrusion is semi-cylindrical and has an arc-shaped outer peripheral surface and a semi-annular bottom surface perpendicular to the arc-shaped outer peripheral surface, the semi-annular bottom surface is used to interfere with the step surface of the annular step.

17. The connector according to claim 16, wherein when the first connector component is rotated around the elastic buckle between the assembly position and the disassembly position, the radial protrusion slides along the arc-shaped outer peripheral surface of the locking protrusion.

18. The connector according to claim 17, wherein:
the locking protrusion also has a flat inner side surface, and the flat inner side surfaces of the pair of locking protrusions face each other;
with the first connector component is in the assembly position, the radial protrusion is close to a side edge where the arc-shaped outer peripheral surface intersects with the flat inner side surface;
with the first connector component is in the disassembly position, the radial protrusion is located in a circumferential middle location of the arc-shaped outer peripheral surface.

19. The connector according to claim 18, wherein:
with the first connector component is in the assembly position, the elastic buckle is not pressed by the radial protrusion, so that the radial interference amount between the elastic buckle and the engagement hole is equal to the predetermined interference amount; and
with the first connector component is in the disassembly position, the elastic buckle is pressed by the radial protrusion, so that the radial interference amount between the elastic buckle and the engagement hole is less than the predetermined interference amount, in order to reduce an unlocking force required to unlock the elastic buckle.

20. The connector according to claim 19, wherein the predetermined interference amount is equal to the difference between the maximum radial size of the locking protrusion on the elastic buckle and the inner diameter of the first aperture portion of the engagement hole.
